(19) United States
(12) Patent Application Publication
(10) Pub. No.: US 2003/0071827 A1
(43) Pub. Date: Apr. 17, 2003

(54) Anti-aliasing method with z-merge

(76) Inventor: Shih-Yang Wang, Banchiau City (TW)

Correspondence Address: RABIN & CHAMPAGNE, PC, 1101 14TH STREET, NW, SUITE 500, WASHINGTON, DC, 20005, US

(21) Appl. No.: 10/256,086

(22) Filed: Sep. 27, 2002

(30) Foreign Application Priority Data
Oct. 16, 2001 (TW) 090125603

(51) Int. Cl. G09G 5/00

(52) U.S. Cl. 345/611

(57) ABSTRACT

An anti-aliasing method with z-merge, for anti-aliasing a non-vector 3D intersection curve defined by an intersection of a first surface SF₁ and a second surface SF₂. The vision surface SF₃ is defined by the overlapped first surface SF₁ and the second surface SF₂. The anti-aliasing method with z-merge includes the following steps: (a) setting a depth tolerance value and setting a depth range accordingly; (b) selecting an anti-aliasing area in the vision surface SF₃ near the 3D intersection curve according to the depth range; and (c) merging the first surface SF₁ and the second surface SF₂ within the anti-aliasing area to generate a result surface SFr=F(Zr, Cr, Wr), wherein the result surface SFr is located on the vision surface SF₃.

This application incorporates by reference Taiwan application Serial No. 090125603, filed Oct. 16, 2001.

### BACKGROUND OF THE INVENTION

1. Field of the Invention

The invention relates in general to a method for image processing, and more particularly to an anti-aliasing method.

2. Description of the Related Art

The computer graphics systems define images on the display device by bit-mapped images and vector graphics. Vector graphics enable the user to manipulate vector elements as units and can be scalable without losing information details and remain smooth at any size. The image in FIG. 1A is representative of a vector graphic in the conventional computer graphics system. The outer edges of the left vector triangle 110 and the right vector triangle 112 and the intersection thereof are smooth lines. Bit-mapped images are composed of pixels and are typical of paint programs, which treat images as collections of dots rather than as shapes. The bit-mapped images are best used for photographs and images with subtle shading or non-uniform shading. There are two aspects to every bit-mapped image—its size (width and height in inches) and resolution (the number of pixels per inch). The lesser number of pixels in an image or the larger a bit-mapped image is displayed, the more jagged it appears.

When the vector graphics are required to be transformed into the bit-mapped image to be rendered on the display device, the pixels can visually lead to jagged or staircase edges due to the pixels' discrete nature and due to insufficient sampling. The image in FIG. 1B is representative of a bit-mapped image in the conventional computer graphics system and is enlarged to show the fact that the edges of a bit-mapped image become jagged as it is scaled up, due to the effects of aliasing. As shown in FIG. 1B, the outer edges of the left bit-mapped triangle 120 and the right bit-mapped triangle 122 and the intersection thereof are jagged. The aliasing effects worsen the quality of the images.

Anti-aliasing is the application of subtle transitions in the pixels along the edges of images to minimize the jagged effect. The jagged appearance of bit-mapped images can be partially overcome with the use of an anti-aliasing technique. The process of removing higher frequencies from a signal to decrease the sampling frequency needed is called low-pass filtering. There are basically two ways to apply anti-aliasing to an image; one is super-sampling and the other is sub-pixel sampling. The super-sampling approach is to increase the number of samples taken and then resample back to the actual size. The sub-pixel sampling approach is to blur the edges in the image along a vector path while leaving the rest of the image substantially the same. Performing the computation of the super-sampling or the sub-pixel sampling approach requires multiple sample points within or near a pixel.

However, the 3D intersection curve generated by an intersection of surfaces fails to be parameterized by a vector description and thus the sub-pixel sampling cannot be applied to anti-aliasing the 3D intersection curve. Additionally, the 3D intersection curve is the only part needing anti-aliasing and thus the super-sampling is not suitable and not required for the entire graph.

### SUMMARY OF THE INVENTION

It is therefore an object of the invention to provide an anti-aliasing method with z-merge, which can effectively anti-alias a non-vector 3D intersection curve without being computationally expensive.

The invention achieves the above-identified object by providing an anti-aliasing method with z-merge, for anti-aliasing a non-vector 3D intersection curve defined by an intersection of a first surface SF₁ and a second surface SF₂, wherein a vision surface SF₃ is defined by the overlapped first surface SF₁ and the second surface SF₂, the pixel Pi(Zi, Ci, Wi) is on the ith surface SFi, and Zi, Ci, and Wi respectively represent a depth value, a color value, and a weight value of the pixel Pi on the ith surface SFi. The anti-aliasing method with z-merge includes the following steps: (a) setting a depth tolerance value and setting a depth range accordingly; (b) selecting an anti-aliasing area in the vision surface SF₃ near the 3D intersection curve according to the depth range; and (c) merging the first surface SF₁ and the second surface SF₂ within the anti-aliasing area to generate a result surface SFr=F(Zr, Cr, Wr), wherein the result surface SFr is located on the vision surface SF₃. The merging step (c) further includes the steps of: (c1) parameterizing the depth range and obtaining a depth parameter nFactor; (c2) setting a first multiplier nFactor₁ of the first surface SF₁ and a second multiplier nFactor₂ of the second surface SF₂; (c3) calculating a result weight value Wr of the result surface SFr; and (c4) obtaining a result color value Cr of the result surface SFr by interpolation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A shows a vector graphic in the conventional computer graphics system;

FIG. 1B shows a bit-mapped image in the conventional computer graphics system;

FIG. 2A show two 3D surfaces without intersection;

FIG. 2B shows a non-vector 3D intersection curve defined by an intersection of two 3D surfaces;

FIG. 3A is a cross-sectional view taken on the line 3A-3A of FIG. 2B;

FIG. 3B is an enlarged view of the anti-aliasing area in FIG. 3A;

FIG. 4 is a flowchart of an anti-aliasing method with z-merge according to the preferred embodiment of the invention;

FIG. 5 is a flowchart of the method for merging a result surface SFr in the anti-aliasing area R according to the preferred embodiment of the invention; and

FIGS. 6A-6C show the procedures of the anti-aliasing method with z-merge according to the preferred embodiment of the invention applied to the overlapping of multiple surfaces.

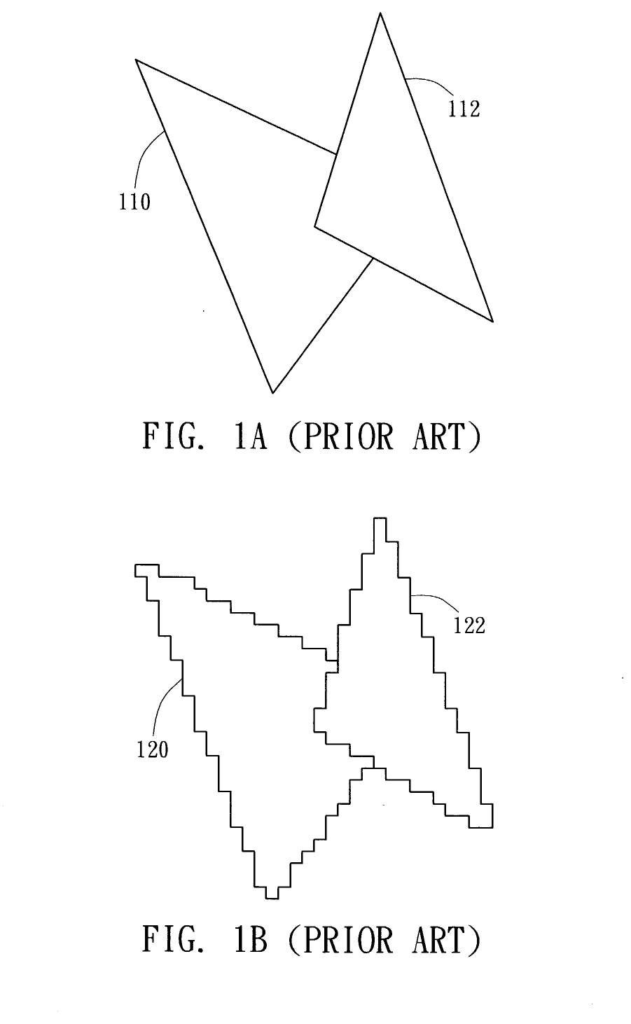

### DETAILED DESCRIPTION OF THE INVENTION

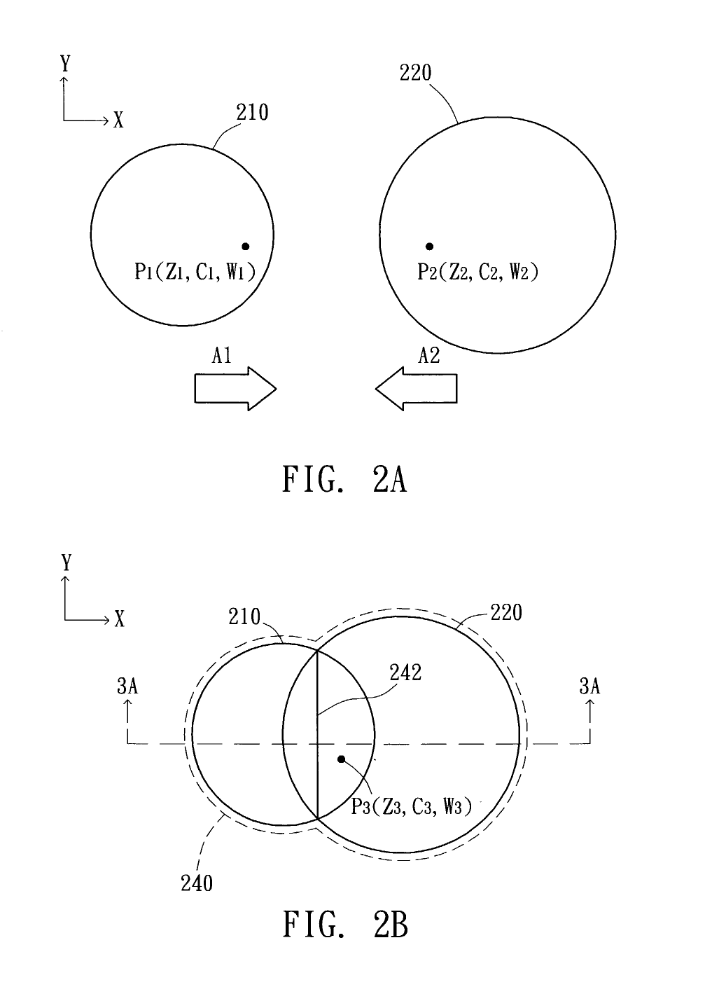

Please refer to FIGS. 2A and 2B. Two 3D surfaces without intersection are shown in FIG. 2A. The first surface SF₁ 210 and the second surface SF₂ 220 are independent 3D surfaces where the pixel Pi(Zi, Ci, Wi) is on the ith surface SFi, and Zi, Ci, and Wi respectively represent a depth value, a color value, and a weight value of the pixel Pi on the ith surface SFi, and i=1 or 2. Before using the method of anti-aliasing with z-merge, the two 3D surfaces 210 and 220 on the X-Y plane move along the directions of arrow signs A1 and A2 respectively, and then form an intersection, as shown in FIG. 2B. The overlapped first surface SF₁ 210 and the second surface SF₂ 220 form a visible surface, defined as a vision surface SF₃ 240, and the pixel P₃(Z₃, C₃, W₃) is on the vision surface SF₃ 240, wherein Z₃, C₃ and W₃ respectively represent a depth value, a color value, and a weight value of the pixel P₃ on the vision surface SF₃ 240. The intersection between the first surface SF₁ 210 and the second surface SF₂ 220 forms a non-vector 3D intersection curve 242.

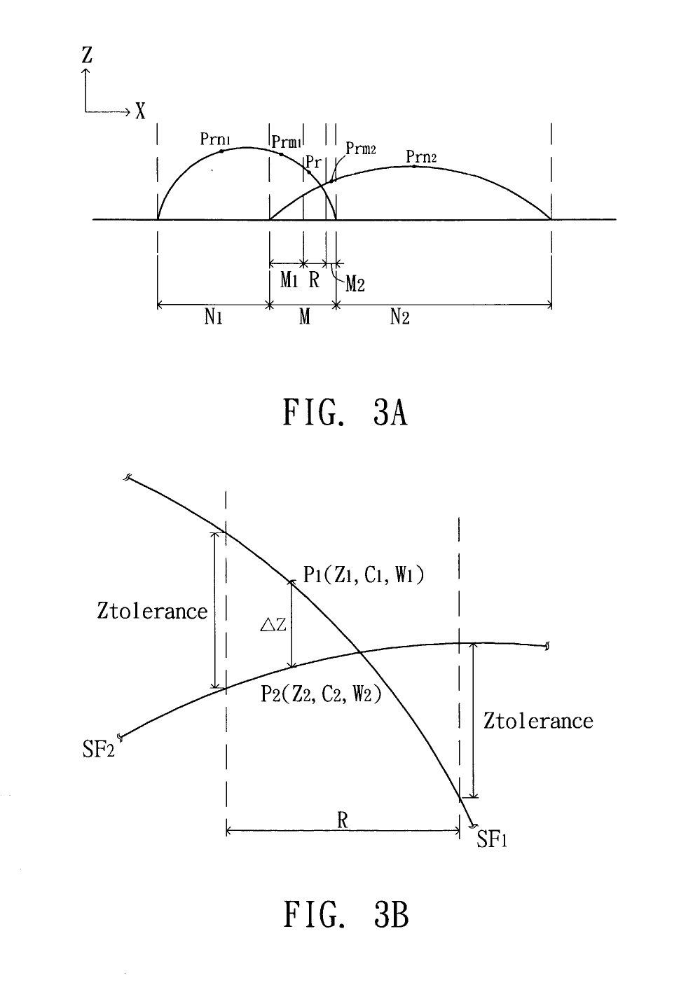

Referring to FIG. 3A, a cross-sectional view taken on the line 3A-3A of FIG. 2B is shown. When the first surface SF₁ 210 and the second surface SF₂ 220 overlap, the overlapping part is in the region M, whereas the non-overlapped sections are in the regions N₁ and N₂. Regardless of the background, the color value of the pixel Prn₁ in region N₁ is the product of the weight value W₁ and color value C₁, and the rendered color of the pixel Prn₂ in region N₂ is the product of the weight value W₂ and color value C₂. The pixels on the intersection of the two 3D surfaces visually lead to jagged or staircase edges due to the discrete nature of the pixels and due to insufficient sampling. However, the 3D intersection curve generated by an intersection of surfaces fails to be parameterized by a vector equation and thus the sub-pixel sampling cannot be applied to anti-aliasing the 3D intersection curve along a vector path. While using z-merge, the depth sorting procedure is performed on the overlapping 3D surfaces to determine the depth value of the rendered pixel of the overlapped part. The depth values of the adjacent overlapped pixels on the different surfaces, which are intermediate data obtained during the depth sorting procedure, are operational data for the anti-aliasing method with z-merge according to the invention. The depth value is the relative height of the pixels, which can be determined by the z values of the pixels.

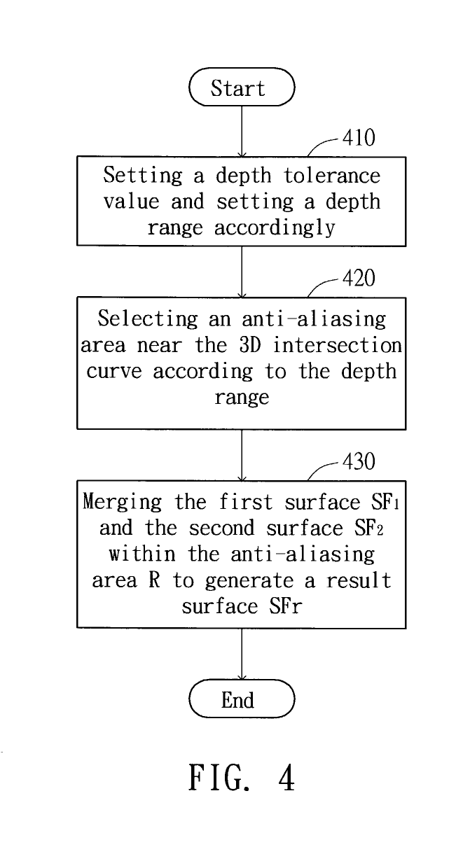

Referring to FIG. 4, a flowchart of an anti-aliasing method with z-merge according to the preferred embodiment of the invention is shown. The anti-aliasing method with z-merge is used for anti-aliasing the non-vector 3D intersection curves defined by an intersection of 3D surfaces. The area for anti-aliasing is determined by the depth values of the adjacent overlapping pixels near the 3D intersection curves. As shown in step 410, first, a depth tolerance value Ztolerance is set, and then a depth range is set accordingly, such as [-Ztolerence, Ztolerance], where Ztolerence is a positive number. Then, an adjacent depth value ΔZ of the first surface SF₁ 210 and the second surface SF₂ 220 near the 3D intersection curve is obtained. Referring to FIG. 3B, an enlarged view of the anti-aliasing area as shown in FIG. 3A is illustrated. The adjacent depth value ΔZ is the difference in depth between the two adjacent pixels P₁(Z₁, C₁, W₁) and P₂(Z₂, C₂, W₂), i.e. ΔZ=Z₁−Z₂. In step 420, the surface with the adjacent depth value ΔZ that falls in the depth range [-Ztolerence, Ztolerance] is selected as the anti-aliasing area R. The anti-aliasing method with z-merge can be applied to the adjacent overlapped pixels near the 3D intersection curves in the depth range. For example, the color values and weight values of the adjacent overlapped pixels are blurred respectively so that the first surface SF₁ and the second surface SF₂ within the anti-aliasing area are merged to generate a result surface SFr=F(Zr, Cr, Wr), wherein Zr, Cr, and Wr respectively represent a depth value, a color value, and a weight value of the pixel on the result surface SFr.

As shown in FIG. 3A, the region R falls within the region M, and consequently the result surface SFr is located on the vision surface SF₃. When the adjacent depth value ΔZ is a positive number, the depth value Zr of the pixel Prm₁(Zr, Cr, Wr) on the vision surface is equal to the depth value Z₁ of the pixel on the first surface SF₁, i.e. when Z₁>Z₂ then Zr=Z₁. When the adjacent depth value ΔZ is a negative number, the depth value Zr of the pixel Prm₂(Zr, Cr, Wr) on the vision surface is equal to the depth value Z₂ of the pixel on the second surface SF₂, i.e. when Z₁<Z₂ then Zr=Z₂. Additionally, when the adjacent depth value ΔZ is a positive number and smaller than the depth tolerance value, the color value C₃ of the vision surface SF₃ in region M₁ satisfies the equation: C₃=[W₁×C₁+(1−W₁)×W₂×C₂]÷W₃, and the rendered color of the vision surface SF₃ is a product of the weight value W₃ and the color value C₃(W₃×C3=W₁×C₁+(1−W₁)×W₂×C₂). When the adjacent depth value ΔZ is a negative number and larger than the negative depth tolerance value, −Ztolerance, the color value C₃ of the vision surface SF₃ in region M₂ satisfies the equation: C₃=[(1−W₂)×W₁×C₁+W₂×C₂]÷W₃ and the rendered color of the vision surface SF₃ is a product of the weight value W₃ and the color value C₃((1−W₂)×W₁×C₁+W₂×C₂).

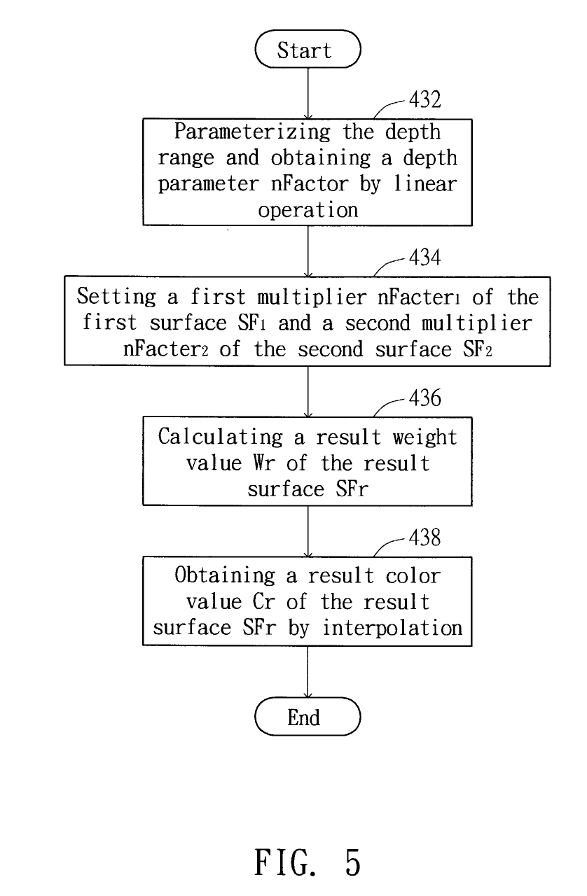

Referring to FIG. 5, a flowchart of the method for merging a result surface SFr in the anti-aliasing area R according to the preferred embodiment of the invention is shown. The method for merging the result surface SFr in the anti-aliasing area R is described in the following. First, the depth range [-Ztolerence, Ztolerance] is parameterized, and then a depth parameter nFactor is obtained by a linear operation in step 432. The depth parameter nfactor is a function of Z₁ and Z₂, where nFactor(Z₁, Z₂)=ΔZ /Ztolence×0.5+0.5. In the anti-aliasing area R, the adjacent depth value ΔZ falls within the depth range [-Ztolerence, Ztolerance]. The nFactor(Z₁, Z₂) lies between 1.0 and 0.0, so that rendered color of the pixels in the anti-aliasing area R after anti-aliasing gradually varies between W₁×C₁+(1−W₁)×W₂×C₂ and (1−W₂)×W₁×C₁+W₂×C₂. Next, in step 434, the first multiplier nFactor₁ of the first surface SF₁ is set within [1, 1−W₂], and therefore the first multiplier nFactor₁ is a function of W₂, Z₁ and Z₂ and can be parameterized as nFactor₁(W₂, Z₁, Z₂)=1−(1−-nFactor)×W₂. The second multiplier nFactor₂ of the second surface SF₂ is set within [1−W₁, 1], and therefore the second multiplier nFactor₂ is a function of W₁, Z₁ and Z₂ and can be parameterized as nFactor₂(W₁, Z₁, Z₂)=1−-nFactor×W₂. As shown in the following step 436, the result weight value Wr (W₁, W₂) of the result surface SFr is calculated. Since the result weight value Wr represents opacity, the higher the weight value Wr, the lower the transparency (1−Wr) is. Furthermore, the result surface SFr is opaque if the result weight value Wr=1. The transparency (1−Wr) of the overlapped first surface SF₁ and second surface SF₂ is the product of the transparency (1−W₁) of the first surface SF₁ and the transparency (1−W₂) of the second surface SF₂. Then, the result weight value Wr is determined to be Wr=W₁+W₂−W₁×W₂ where Wr lies between [0,1]. In final step 438, the rendered color of the result surface SFr is the product of the result weight value Wr and the result color value Cr, wherein the result color value Cr is a function of Z₁, Z₂, C₁, C₂, W₁ and W₂. The rendered color of the result surface SFr is Wr×Cr=W₁×C₁×nFactor₁+W₂×C₂×nFactor₂ and can be obtained by linear interpolation. The result color value Cr(Z₁, Z₂, C₁, C₂, W₁, W₂) is [W₁×C₁×nFactor₁+W₂×C₂×nFactor₂]÷Wr={W₁×C₁×[1−(1−nFactor)×W₂]+W₂×C₂×(1−nFactor×W₂)}÷(W₁+W₂−W₁×W₂), obtained by replacing the equations of nFactor₁(W₂, Z₁, Z₂), nFactor₂(W₁, Z₁, Z₂), and Wr(W₁, W₂). Thus, the parameterized result surface SFr is consequently obtained.

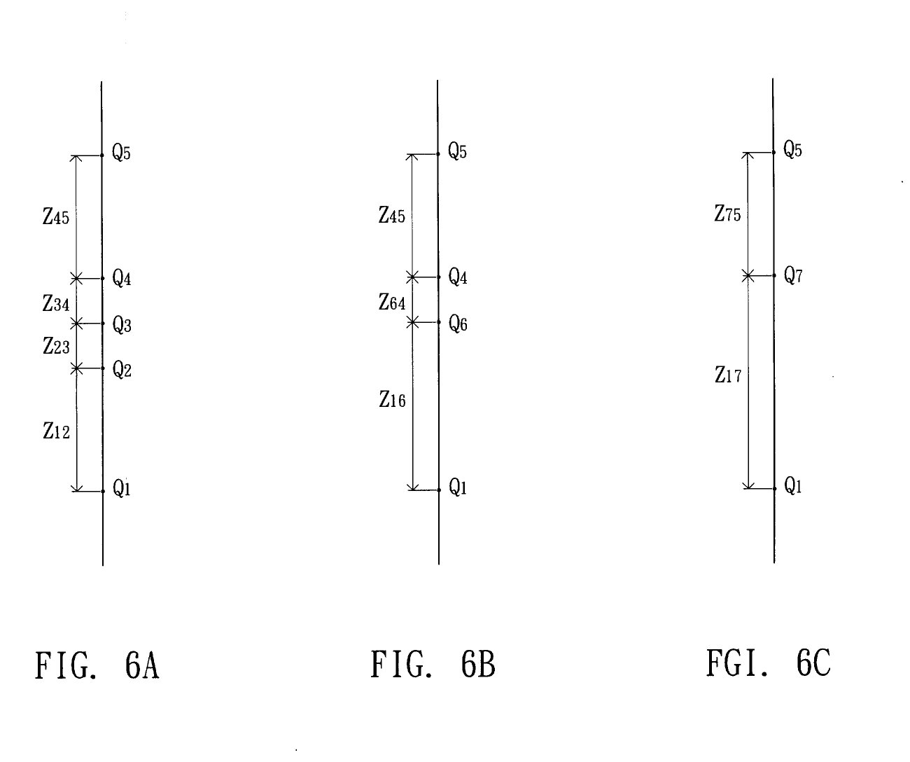

In addition, the depth values of the adjacent overlapping pixels of the different surfaces, which are intermediate data obtained during the depth sorting procedure, are operational data for the anti-aliasing method with z-merge according to the invention. The anti-aliasing method with z-merge of the invention can be applied to the operation of the depth sorting procedure. The adjacent overlapping pixels within the given depth range [−Ztolerance, Ztolerance] are merged into a single pixel for performing the depth sorting procedure. As shown in FIGS. 6A to 6C, the procedures of the anti-aliasing method with z-merge according to the preferred embodiment of the invention are applied to the overlapping of multiple surfaces. Referring to FIG. 6A, five surfaces overlap and form five adjacent overlapped pixels Q₁, Q₂, Q₃, Q₄, and Q₅. The adjacent depth value ΔZ between the nearest two points are z₁₂, z₂₃, z₃₄, and z₄₅. The adjacent depth value Z₂₃ between pixels Q₂ and Q₃ and the adjacent depth value z₄₅ between pixels Q₄ and Q₅ fall within the depth range [−Ztolerance, Ztolerance]. The pixels Q₂ and Q₃ are first merged into a new single pixel Q₆ and then the pixels Q₂ and Q₃ are removed. The position of the pixel Q₆ is the original position of the pixel Q₃ and therefore the depth z₆ of the pixel Q₆ is the original depth z₃ of the pixel Q₃. The color value c₆ and weight value w₆ of the pixel Q₆ are obtained according to the anti-aliasing method with z-merge. As shown in FIG. 6B, the adjacent depth value z₆₄ between pixels Q₆ and Q₄ is equal to the adjacent depth value z₃₄ between the original pixel Q₃ and the pixel Q₄. The adjacent depth value z₆₄ falls within the depth range [−Ztolerance, Ztolerance] as well. Therefore, the pixels Q₆ and Q₄ are then merged into a new single pixel Q₇, and then the pixels Q₆ and Q₄ are removed. The position of the pixel Q₇ is the original position of the pixel Q₄, and therefore the depth z₇ of the pixel Q₇ is the original depth z₄ of the pixel Q₄. The color value c₇ and weight value w₇ of the pixel Q₇ are obtained according to the anti-aliasing method with z-merge. As shown in FIG. 6C, the five adjacent overlapped pixels Q₁, Q₂, Q₃, Q₄, and Q₅ have been merged into three adjacent overlapped pixels Q₁, Q₇, and Q₅ after twice performing the anti-aliasing method with z-merge according to the invention. The method of combining the anti-aliasing operation with the depth sorting procedure enhances the speed of the image processing.

The anti-aliasing method with z-merge according to the preferred embodiment of the invention can effectively anti-alias a non-vector 3D intersection curve defined by an intersection of 3D surfaces. It solves the problem that the 3D intersection curve fails to be parameterized by a vector description for sub-pixel sampling. The anti-aliasing method according to the invention z-merges the adjacent overlapped pixels near the 3D intersection curve by directly using the intermediate data obtained during the depth sorting procedure. Furthermore, it prevents the unnecessary computation of anti-aliasing the entire graph, rather than just the 3D intersection curve. In addition, the way to combine the anti-aliasing operation with the depth sorting procedure enhances the speed of the image processing, without being computationally expensive.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An anti-aliasing method with z-merge, for anti-aliasing a non-vector 3D intersection curve defined by an intersection of a first surface SF₁ and a second surface SF₂, wherein a vision surface SF₃ is defined by the overlapped first surface SF₁ and the second surface SF₂, the pixel Pi(Zi, Ci, Wi) is on the ith surface SFi, and Zi, Ci, and Wi respectively represent a depth value, a color value, and a weight value of the pixel Pi on the ith surface SFi, the method comprising the steps of:
(a) setting a depth tolerance value and setting a depth range accordingly;
(b) selecting an anti-aliasing area in the vision surface SF₃ near the 3D intersection curve according to the depth range; and
(c) merging the first surface SF₁ and the second surface SF₂ within the anti-aliasing area to generate a result surface SFr=F(Zr, Cr, Wr), wherein the result surface SFr is located on the vision surface SF₃.

2. The anti-aliasing method according to claim 1, wherein said step (b) further comprises obtaining an adjacent depth value ΔZ and the adjacent depth value ΔZ is a difference in depth between two adjacent pixels P₁(Z₁, C₁, W₁) and P₂(Z₂, C₂, W₂) where ΔZ=Z₁−Z₂.

3. The anti-aliasing method according to claim 2, wherein the adjacent depth value ΔZ falls within the depth range.

4. The anti-aliasing method according to claim 3, wherein said merging step (c) further comprises the steps of:
parameterizing the depth range and obtaining a depth parameter nFactor;
setting a first multiplier nFactor₁ of the first surface SF₁ and a second multiplier nFactor₂ of the second surface SF₂;
calculating a result weight value Wr of the result surface SFr; and
obtaining a result color value Cr of the result surface SFr by interpolation.

5. The anti-aliasing method according to claim 4, wherein the depth parameter nFactor is a function of Z₁ and Z₂.

6. The anti-aliasing method according to claim 5, wherein the depth parameter nFactor is calculated by linear operation.

7. The anti-aliasing method according to claim 6, wherein the result color value Cr is a function of Z₁, Z₂, C₁, C₂, W₁, and W₂.

8. The anti-aliasing method according to claim 7, wherein the result color value Cr is calculated by linear interpolation.

9. The anti-aliasing method according to claim 8, wherein the first multiplier nFactor₁ is a function of W₂, Z₁, and Z₂.

10. The anti-aliasing method according to claim 9, wherein the second multiplier nFactor₂ is a function of W₁, Z₁, and Z₂.

11. The anti-aliasing method according to claim 10, wherein the result weight value Wr is a function of W₁ and W₂.

12. The anti-aliasing method according to claim 11, wherein a rendered color of the result surface SFr is a product of the result weight value Wr and the result color value Cr.

13. The anti-aliasing method according to claim 4, wherein the depth value Z₃ of the pixel P₃ on the vision surface SF₃ is equal to the depth value Z₁ of the pixel P₁ on the first surface SF₁ when the adjacent depth value ΔZ is a positive number, where Z₃=Z₁ while Z₁>Z₂.

14. The anti-aliasing method according to claim 4, wherein the depth value Z₃ of the pixel P₃ on the vision surface SF₃ is equal to the depth value Z₂ of the pixel P₂ on the second surface SF₂ when the adjacent depth value ΔZ is a negative number, where Z₃=Z₂ while Z₁<Z₂.

15. A computer readable recording medium, used to record an anti-aliasing method with z-merge, for anti-aliasing a non-vector 3D intersection curve defined by an intersection of a first surface SF₁ and a second surface SF₂, wherein a vision surface SF₃ is defined by the overlapped first surface SF₁ and the second surface SF₂, the pixel Pi(Zi, Ci, Wi) is on the ith surface SFi, and Zi, Ci, and Wi respectively represent a depth value, a color value, and a weight value of the pixel Pi on the ith surface SFi, the method comprising the steps of:
(a) setting a depth tolerance value and setting a depth range accordingly;
(b) selecting an anti-aliasing area in the vision surface SF₃ near the 3D intersection curve according to the depth range; and
(c) merging the first surface SF₁ and the second surface SF₂ within the anti-aliasing area to generate a result surface SFr=F (Zr, Cr, Wr), wherein the result surface SFr is located on the vision surface SF₃.

16. The computer readable recording medium according to claim 15, wherein said step (b) further comprises obtaining an adjacent depth value ΔZ and the adjacent depth value ΔZ is a difference in depth between two adjacent pixels P₁ (Z₁, C₁, W₁) and P₂ (Z₂, C₂, W₂), where ΔZ=Z₁−Z₂.

17. The computer readable recording medium according to claim 16, wherein the adjacent depth value ΔZ falls within the depth range.

18. The computer readable recording medium according to claim 17, wherein said merging step (c) further comprises the steps of:
parameterizing the depth range and obtaining a depth parameter nFactor;
setting a first multiplier nFactor₁ of the first surface SF₁ and a second multiplier nFactor₂ of the second surface SF₂;
calculating a result weight value Wr of the result surface SFr; and
obtaining a result color value Cr of the result surface SFr by interpolation.

19. The computer readable recording medium according to claim 18, wherein the depth parameter nFactor is a function of Z₁ and Z₂.

20. The computer readable recording medium according to claim 19, wherein the depth parameter nFactor is calculated by linear operation.

21. The computer readable recording medium according to claim 20, wherein the result color value Cr is a function of Z₁, Z₂, C₁, C₂, W₁ and W₂.

22. The computer readable recording medium according to claim 21, wherein the result color value Cr is calculated by linear interpolation.

23. The computer readable recording medium according to claim 22, wherein the first multiplier nFactor₁ is a function of W₂, Z₁ and Z₂.

24. The computer readable recording medium according to claim 23, wherein the second multiplier nFactor₂ is a function of W₁, Z₁ and Z₂.

25. The computer readable recording medium according to claim 24, wherein the result weight value Wr is a function of W₁ and W₂.

26. The computer readable recording medium according to claim 25, wherein a rendered color of the result surface SFr is a product of the result weight value Wr and the result color value Cr.
